(19) United States
(12) Patent Application Publication
(10) Pub. No.: US 2023/0380028 A1
(43) Pub. Date: Nov. 23, 2023

(54) LIGHT DIMMING SYSTEM

(71) Applicant: SENGLED CO., LTD., Shanghai (CN)

(72) Inventors: Yehua WAN, Jiaxing (CN); Songan YE, Jiaxing (CN)

(21) Appl. No.: 18/247,025

(22) PCT Filed: Sep. 8, 2021
(86) PCT No.: PCT/CN2021/117246

§ 371 Date: Mar. 28, 2023

(30) Foreign Application Priority Data
Sep. 29, 2020 (CN) 202022185358.X

(51) Int. Cl. H05B 45/10; H05B 45/325; H05B 45/37

(52) U.S. Cl. CPC H05B 45/10; H05B 45/325; H05B 45/37

(57) ABSTRACT

A light dimming system includes a rectifier, a voltage acquisitor, a controller, a driver connected to the controller and the rectifier, a dimmer starter, and a power supplier. The rectifier is used to connect to mains power supply via a switch or a dimmer to convert the input alternating current (AC) into a direct current (DC). The voltage acquisitor is used to receive the DC from the rectifier, obtain status of the mains power supply. The controller is used to generate a driver control signal according to the status of the mains power supply. The driver control signal is an analog control signal or a pulse width modulation (PWM) control signal. The driver generates a corresponding driving current according to the driver control signal to enable the lighting module to emit light. The dimmer starter is configured to turn on the dimmer according to a conduction control signal.

### CROSS-REFERENCE TO RELATED APPLICATION

This application is a national stage entry of PCT application PCT/CN2021/117246, filed on Sep. 8, 2021, which claims priority to Chinese Patent Application No. 202022185358.X, filed on Sep. 29, 2020, the entire contents of both of which are incorporated herein by reference.

### TECHNICAL FIELD

The present disclosure relates to the field of lighting technology and, in particularly, to a light dimming system.

### BACKGROUND

With the development of energy conservation and the increased environmental protection awareness of people, light dimming systems have been more and more widely used in daily life and work. The existing light dimming systems may control the input of mains power supply with different scenarios, such as with or without a dimmer. In existing intelligent light dimming systems, the pulse width modulation (PWM) dimming method of different pulse width or period is generally used to dimming a lighting system. The use of PWM dimming method in the lighting system with or without a dimmer may cause the lighting system to produce audible noise, and may cause a problem of incompatibility between an intelligent light dimming system and a traditional lighting circuit with a wall dimmer, thereby causing the light source in the light dimming system to flicker when it is lit.

### SUMMARY

In accordance with the disclosure, there is provided a light dimming system including a rectifier, a voltage acquisitor connected to the rectifier, a controller connected to the voltage acquisitor, a driver connected to the controller and the rectifier, a dimmer starter connected to the controller, and a power supplier. The rectifier is used to connect to mains power supply via a switch or a dimmer to convert the input alternating current (AC) into a direct current (DC). The voltage acquisitor is used to receive the DC from the rectifier, obtain status of the mains power supply, and send the status of the mains power supply to the controller. The controller is used to generate a driver control signal according to the status of the mains power supply from the voltage acquisitor, send the driver control signal to the drive, generate a conduction control signal in response to the rectifier being connected to the mains power supply via a dimmer, and send the conduction control signal to the dimmer starter. The driver control signal is an analog control signal or a pulse width modulation (PWM) control signal. The driver is used to generate a corresponding driving current according to the driver control signal to enable the lighting module to emit light. The dimmer starter is used to control the dimmer to turn on according to the conduction control signal. The power supplier is used to connect to the mains power supply and provide working power for the controller.

### BRIEF DESCRIPTION OF THE DRAWINGS

FIG. 1 is a schematic diagram of a light dimming system consistent with the present disclosure.

FIG. 2 is a schematic structural diagram of a voltage acquisitor of an example light dimming system consistent with the present disclosure.

FIG. 3 is a schematic structural diagram of a driver of a light dimming system consistent with the present disclosure.

FIG. 4 is a schematic diagram of an example dimmer starter of a light dimming system consistent with the present disclosure.

FIG. 5 is a schematic diagram of another light dimming system consistent with the present disclosure.

FIG. 6 is a schematic structural diagram of a power supplier of a light dimming system consistent with the present disclosure.

FIG. 7 is a schematic diagram of another light dimming system consistent with the present disclosure.

FIG. 8 is a schematic diagram of another light dimming system consistent with the present disclosure.

FIG. 9 is a schematic diagram of a PWM control signal consistent with the present disclosure.

FIG. 10 is a schematic diagram of another PWM control signal consistent with the present disclosure.

FIG. 11 is a schematic diagram of an analog control signal consistent with the present disclosure.

Reference numerals: Rectifier 101; Voltage acquisitor 102; Controller 103; Driver 104; Dimmer starter 105; Power supplier 106; Signal receiver 107; Lighting module 108; Conductor 109.

### DETAILED DESCRIPTION OF THE EMBODIMENTS

The embodiments of the present disclosure are described in detail below. The embodiments described below with reference to the drawings are exemplary and are only used to explain the present disclosure and should not be understood as a limitation to the present disclosure.

In the description of the present disclosure, the terms “center,” “lengthways,” “lateral,” “length,” “width,” “thickness,” “upper,” “lower,” “front,” “back,” “left,” “right,” “vertical,” “horizontal,” “top,” “bottom,” “inner,” “outer,” “clockwise,” “counterclockwise,” “axial,” “radial,” “circumferential,” etc., which indicate the orientation or positional relationship based on the orientation or positional relationship shown in the drawings, are only used for conveniently and simply describing the present disclosure, rather than indicating or implying pointed devices or elements must have a specific orientation or be constructed and operated in a specific orientation, and should not be understood as a limitation of the present disclosure.

The terms “first” and “second” are used for descriptive purposes only and should not be understood as indicating or implying relative importance or implicitly indicating the number of technical features indicated. Thus, a feature described with “first” or “second” may include at least one of such feature explicitly or implicitly. In the description of the present disclosure, “multiple” or “plurality of” means two or more, unless otherwise specified.

In the description of the present disclosure, unless otherwise defined and specified, the terms “mount,” “connect,” “fixed to,” etc. should be understood broadly. For example, a connection may be a fixed connection or a detachable connection, or a whole; it may be a mechanical connection, or may be an electrical connection, or may be a communication with each other; it may be a direct connection, or may be an indirect connection via an intermediate medium, or may be an internal connection of two components or the interaction between two components. For persons of ordinary skill in the art, the specific meaning of the above terms in the present disclosure may be understood according to the specific circumstances.

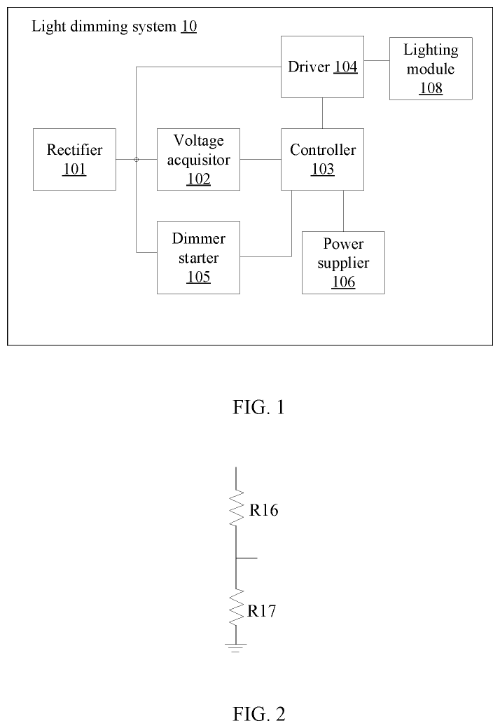

FIG. 1 is a schematic diagram of an example light dimming system 10 consistent with the present disclosure. As shown in FIG. 1, the light dimming system 10 includes a rectifier 101, a voltage acquisitor 102, a controller 103, a driver 104, a dimmer starter 105, and a power supplier 106.

The rectifier 101 is connected to the voltage acquisitor 102, the driver 104, and the dimmer starter 105, respectively. The voltage acquisitor 102 is connected to the controller 103. The controller 103 is connected to the driver 104 and the dimmer starter 105, respectively.

The rectifier 101 is used to connect to the mains power supply via a switch or a dimmer, to convert the input alternating current (AC) into direct current (DC), and to send converted DC to the voltage acquisitor 102.

The voltage acquisitor 102 is used to receive the DC from the rectifier 101, to obtain status of the mains power supply, and to send the status of the mains power supply to the controller 103.

The controller 103 is used to generate a conduction control signal and a driver control signal according to the status of the mains power supply from the voltage acquisitor 102, to send the conduction control signal to the dimmer starter 105, and to send the driver control signal to the driver 104. The driver control signal is an analog control signal or a pulse width modulation (PWM) control signal.

The driver 104 is used to generate a corresponding driving current according to the driver control signal and send the driving current to a lighting module 108.

The dimmer starter 105 is used to control a dimmer to turn on according to the conduction control signal.

The power supplier 106 is used to connect to the mains power supply and provide working power for the controller 103.

The power supplier 106 may be directly connected to the mains power supply. The AC of the mains power supply is converted and stabilized to obtain the DC, which is used as the working power of the controller 103. The power supplier 106 may also be connected to the output terminal of the rectifier 101. The DC output by the rectifier 101 is level-converted and stabilized, and then is output to the controller 103 as the working power of the controller 103.

In an example embodiment, the dimming device connected to the input terminal of the rectifier 101 may be any device for dimming, such as a dimmer, a switch, or a touch screen, etc.

In an example embodiment, there are many ways to design each circuit. To reduce the mutual influence and interference between the circuits, a possible way is to design each circuit as a separate circuit, for example, the voltage acquisitor 102, the dimmer starter 105, and the driver 104. To save space and reduce costs, a possible way is to integrate and design some circuits as a whole. For example, the voltage acquisitor 102, the dimmer starter 105, and the driver 104 may be integrated into the same circuit.

In an example embodiment, the controller 103 may be specifically used to generate the analog control signal as the driver control signal when the status of the mains power supply shows that the dimming device is a dimmer, and generate the PWM control signal as the driver control signal when the status of the mains power supply shows that the dimming device is not a dimmer.

The driver 104 may be specifically used to output a continuous driving current to the lighting module 108 according to the analog control signal when the driver control signal is the analog control signal, output a continuous driving current output to the lighting module 108 when the driver control signal is the PWM control signal and a duty cycle of the PWM control signal is 100%, and output a discontinuous driving current to the lighting module 108 when the driver control signal is the PWM control signal and the duty cycle of the PWM control signal is less than 100%.

In certain applications, the working process of the light dimming system consistent with embodiments of the disclosure includes following processes. The rectifier 101 converts the input AC into DC and sends the converted DC to the voltage acquisitor 102. The voltage acquisitor 102 receives the DC from the rectifier 101, obtains the statues of the mains power supply, and sends the status of the mains power supply to the controller 103. The controller 103 controls whether the dimmer starter 105 is turned on according to the status of the mains power supply from the voltage acquisitor 102. When the status of the mains power supply indicates that there is a dimmer, the controller 103 controls to turn on the dimmer starter 105 and output the analog control signal to the driver 104. When the status of the mains power supply indicates that there is no dimmer, the controller 103 controls to turn off the dimmer starter 105 and output the PWM control signal to the driver 104. The driver 104 outputs a corresponding current to the lighting module 108 according to the analog control signal or the PWM control signal from the controller 103. Specifically, when the signal from the controller 103 is the analog control signal, the driver 104 outputs a continuous current to the lighting module 108 according to the analog control signal. When the signal from the controller 103 is the PWM control signal and the duty cycle of the PWM control signal is 100%, the driver 104 outputs the continuous current to the lighting module 108. When the signal from the controller 103 is the PWM control signal and the duty cycle of the PWM control signal is less than 100%, the driver 104 outputs a discontinuous current to the lighting module 108. Therefore, the lighting module 108 receives the continuous constant current or the discontinuous current and emits light. In some embodiments, the driver 104 may be a linear constant current control circuit. The dimmer starter 105 controls to turn on the dimmer when it is conducted.

The light dimming system consistent with embodiments of the present disclosure includes a rectifier 101, a voltage acquisitor 102, a controller 103, a Driver 104, and a dimmer starter 105. The rectifier 101 is used to connect to the mains power supply through a switch or a dimmer, to convert the input AC into DC, and to send the converted the DC to the voltage acquisitor 102. The voltage acquisitor 102 is connected to the rectifier 101 and is used to receive the DC from the rectifier 101, obtain the status of the mains power supply, and send the status of the mains power supply to the controller 103. The controller 103 is connected to the voltage acquisitor 102 and is used to generate a conduction control signal and a driver control signal according to the status of the mains power supply from the voltage acquisitor 102, to send the conduction control signal to the dimmer starter 105, and to send the driver control signal to the driver 104. The driver control signal is an analog control signal or a PWM control signal. The driver 104 is connected to the controller 103 and is used to generate a corresponding driving current according to the driver control signal, and to send the driving current to the lighting module 108. the dimmer starter 105 is connected to the controller 103 and is used to control the dimmer to turn on according to the conduction control signal. The light dimming system solves the noise problem caused by the PWM dimming when there may be a dimmer or no dimmer in existing technology.

FIG. 2 is a schematic structural diagram of an example voltage acquisitor 102 of an example light dimming system consistent with the disclosure. As shown in FIG. 2, in an example embodiment, the voltage acquisitor 102 includes the sixteenth resistor R16 and the seventeenth resistor R17.

The first terminal of the sixteenth resistor R16 is connected to the rectifier 101, and the second terminal of the sixteenth resistor R16 is connected to the first terminal of the seventeenth resistor R17 and the input terminal of the controller 103, respectively.

In certain applications, an output voltage of the rectifier 101 is collected through a voltage division of the sixteenth resistor R16 and the seventeenth resistor R17, and a collected voltage division signal may indicate whether the dimming device is a dimmer, that is, whether there is a dimmer connected to the mains power supply. The controller 103 may output different driver control signals according to the collected voltage division signal according to whether the mains power supply is connected with a dimmer. For example, the controller 103 may output the analog control signal to generate the driving current when the mains power supply is connected with the dimmer, and may output the PWM control signal to generate the driving current when the mains power supply is connected without the dimmer.

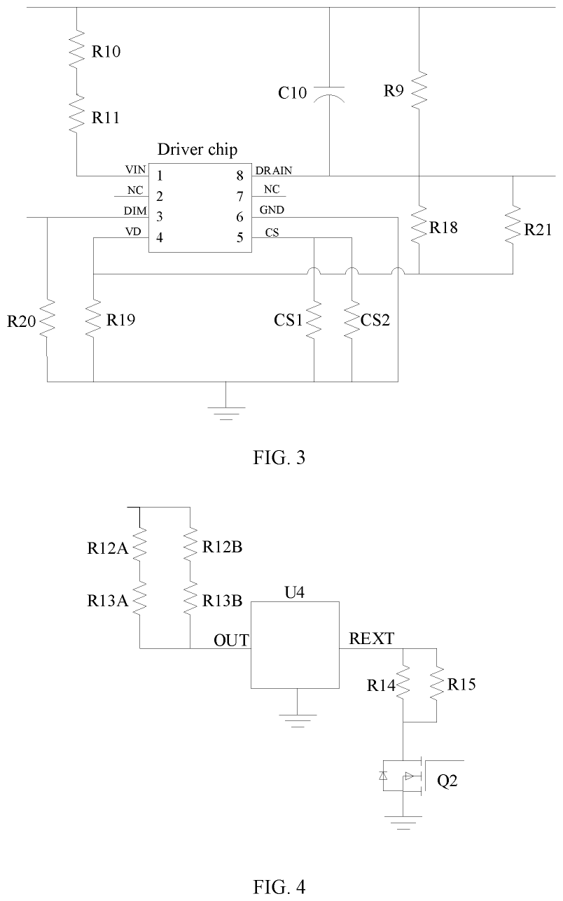

FIG. 3 is a schematic structural diagram of an example Driver 104 of an example light dimming system consistent with the disclosure. As shown in FIG. 3, in an example embodiment, the driver 104 includes a driver chip, the ninth resistor R9, the tenth resistor R10, the eleventh resistor R11, the eighteenth resistor R18, the nineteenth resistor R19, the twentieth resistor R20, the twenty-first resistor R21, the first chip selection resistor CS1, the second chip selection resistor CS2, and the tenth capacitor C10.

The first terminal of the tenth resistor R10 is connected to a cathode of the third diode D3. The second terminal of the tenth resistor R10 is connected to the first terminal of the eleventh resistor R11. The second terminal of the eleventh resistor R11 is connected to the first input terminal of the driver chip. The third input terminal of the driver chip is connected to the output terminal of the conductor. The third input terminal of the driver chip is connected to the first terminal of the twentieth resistor R20. The second terminal of the twentieth resistor R20 is grounded. The first terminal of the nineteenth resistor R19 is connected to the fourth input terminal of the driver chip. The second terminal of the nineteenth resistor R19 is grounded. The first terminal of the tenth capacitor C10 is connected to the cathode of the third diode D3. The second terminal of the tenth capacitor C10 is connected to the first output terminal of the driver chip. The ninth resistor R9 is connected in parallel with the tenth capacitor C10. The second terminal of the tenth capacitor C10 is connected to the first terminal of the eighteenth resistor R18. The second terminal of the eighteenth resistor R18 is connected to the first terminal of the nineteenth resistor R19. The twenty-first resistor R21 is connected in parallel with the eighteenth resistor R18. The ninth resistor R9 is connected in parallel with the lighting module 108. The first chip selection resistor CS1 is connected in parallel with the second chip selection resistor CS2. The first terminal of the second chip selection resistor CS2 is connected to the fourth output terminal of the driver chip. The second terminal of the second chip selection resistor CS2 is grounded.

The driver chip model may be BP5711EJ.

FIG. 4 is a schematic diagram of an example dimmer starter of an example light dimming system consistent with the disclosure. As shown in FIG. 4, in an example embodiment, the dimmer starter includes the twelfth resistor R12A, the thirty-second resistor R12B, the thirteenth resistor R13A, the thirty-third resistor R13B, the fourteenth resistor R14, the fifteenth resistor R15, the dimmer start chip U4, and the second switch transistor Q2.

The first terminal of the twelfth resistor R12A is connected to the output terminal of the rectifier 101. The second terminal of the twelfth resistor R12A is connected to the first terminal of the thirteenth resistor R13A. The first terminal of the thirty-second resistor R12B is connected to the output terminal of the rectifier 101. The second terminal of the thirty-second resistor R12B is connected to the first terminal of the thirty-third resistor R13B. The first terminal of the twelfth resistor R12A is connected to the first terminal of the thirty-second resistor R12B. The second terminal of the thirteenth resistor R13A is connected to the second terminal of the thirty-third resistor R13B. The second terminal of the thirty-third resistor R13B is connected to the output terminal of the dimmer start chip U4. The input terminal of the dimmer start chip U4 is connected to the first terminal of the fourteenth resistor R14 and the first terminal of the fifteenth resistor R15, respectively. The second terminal of the fourteenth resistor R14 is connected to the second terminal of the fifteenth resistor R15. The fourteenth resistor R14 is connected in parallel with the fifteenth resistor R15. The second terminal of the fifteenth resistor R15 is connected to the first terminal of the second switch transistor Q2. The control terminal of the second switch transistor Q2 is connected to the output terminal of the controller 103. The second terminal of the second switch transistor Q2 is grounded.

FIG. 6 is a schematic structural diagram of an example power supplier 106 of an example light dimming system consistent with the disclosure. As shown in FIG. 6, in an example embodiment, the power supplier 106 includes the first diode D1, the second diode D2, the fourth diode D4, the first capacitor C1, the second capacitor C2, the fourth capacitor C4, the fifth capacitor C5, the first inductor L1, the second inductor L2, the second resistor R2, the third resistor R3, the fifth resistor R5, and the power management chip U1.

The power management chip U1 is connected to the controller 103. An anode of the first diode D1 and the anode of the fourth diode D4 are connected to the mains power supply. The cathode of the first diode D1 is connected to the cathode of the fourth diode D4. The first terminal of the first capacitor C1 is connected to the cathode of the first diode D1. The second terminal of the first capacitor C1 is grounded. The input terminal DRAIN of the first inductor L1 is connected to the cathode of the first diode D1. The second terminal of the first inductor L1 is connected to the first terminal of the second capacitor C2. The second terminal of the second capacitor C2 is grounded. The first capacitor C1, the first inductor L1, and the second capacitor C2 form a C-L-C filter circuit. The second terminal of the first inductor L1 is connected to the input terminal of the power management chip U1. The feedback terminal FB of the power management chip U1 is connected to the first terminal of the second resistor R2. The first terminal of the fifth resistor R5 is connected to the feedback terminal FB of the power management chip U1. The output terminal VCC of the power management chip U1 is connected to the second terminal of the fifth resistor R5. The output terminal VCC of the power management chip U1 is connected to the first terminal of the second inductor L2. The second terminal of the second resistor R2 is connected to the second terminal of the second inductor L2. The third output terminal of the power management chip U1 is connected to the first terminal of the fourth capacitor C4. The second terminal of the fourth capacitor C4 is connected to the cathode of the second diode D2. The anode of the second diode D2 is grounded. The first terminal of the fifth capacitor C5 is connected to the second terminal of the second inductor L2. The second terminal of the fifth capacitor C5 is grounded. The third resistor R3 is connected in parallel with the fifth capacitor C5. The second terminal of the third resistor R3 is connected to the input terminal of the controller 103.

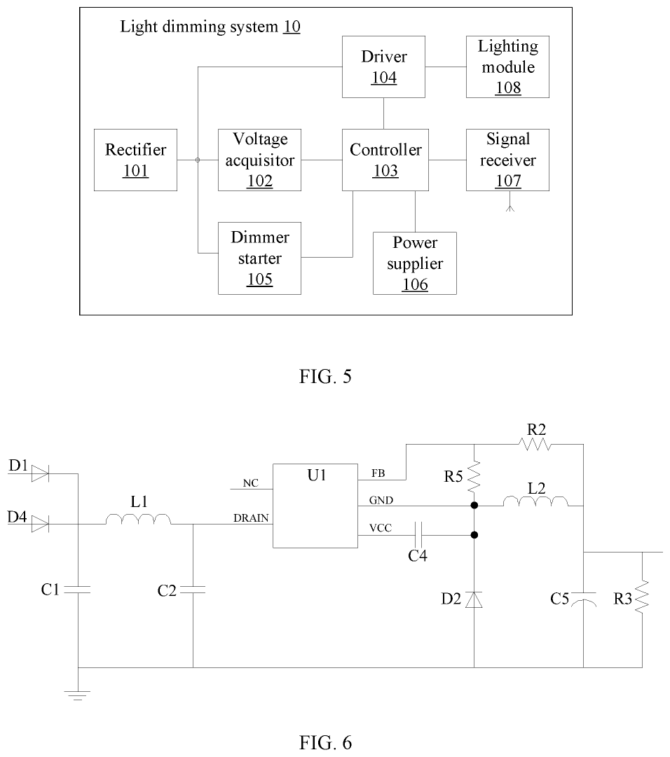

FIG. 5 is a schematic diagram of another example light dimming system consistent with the disclosure. As shown in FIG. 5, in some embodiments, the light dimming system further includes a signal receiver 107.

The signal receiver 107 is connected to the controller 103 and is used to receive dimming instructions from external devices, and to send the received dimming instructions to the controller 103.

The controller 103 is also used to receive the dimming instructions and adjust the driver control signal according to the dimming instructions.

In some embodiments, the signal receiver 107 may also have a sending function to send information of the light dimming system to other devices. For example, the signal receiver 107 may send current lighting brightness to a remote-control device wirelessly communicating with the signal receiver 107.

Specifically, the controller 103 may adjust the output voltage of the analog control signal according to the dimming instructions or may adjust the duty cycle of the PWM control signal according to the dimming instructions.

Therefore, the embodiments of the present disclosure further solve a problem of the incompatibility between an intelligent light dimming system and a traditional lighting circuit with a wall dimmer, which causes an unpleasant sight that the light source in the light dimming system flickers when it is lit.

As shown in FIG. 5, in some embodiments, the light dimming system further includes a lighting module 108.

The lighting module 108 is connected to the driver 104 and used to emit light in response to the driving current.

The lighting module 108 is an LED lighting device, and the LED lighting device may select a suitable LED lamp type according to actual needs, for example, select LED lamp beads or LED filament lamps according to functional requirements.

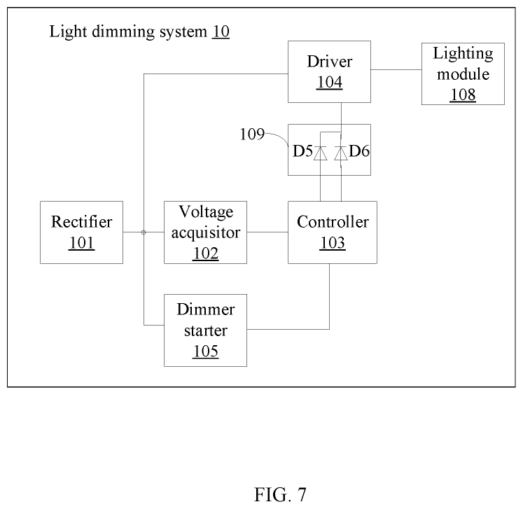

FIG. 7 is a schematic diagram of another example light dimming system consistent with the disclosure. As shown in FIG. 7, on the basis of the above-described embodiments, for example, on the basis of the embodiments shown in FIG. 1, the controller 103 includes the first output terminal to output the analog control signal and the second output terminal to output the PWM control signal, and the light dimming system further includes a conductor 109.

The conductor 109 is connected to the first output terminal of the controller 103, the second output terminal of the controller 103, and the driver 104. The conductor 109 is used to receive the analog control signal from the first output terminal of the controller 109 and send the analog control signal to the driver 104, or to receive the PWM control signal from the second output terminal of the controller 109 and send the PWM control signal to the driver 104.

Specifically, the conductor includes the fifth diode D5 and the sixth diode D6.

The anode of the fifth diode D5 and the anode of the sixth diode D6 are simultaneously connected to the output terminals of the controller 103, respectively. The cathode of the fifth diode D5 and the cathode of the sixth diode D6 are simultaneously connected to the input terminal of the driver 104.

When the input of the mains power supply is controlled by the dimmer, the fifth diode D5 is conducted to receive the analog control signal from the controller 103 and send the analog control signal to the input terminal of the driver 104, thereby enabling the driver 104 to provide a continuous and constant current to the lighting module 108 according to the analog control signal.

When the input of the mains power supply is not controlled by the dimmer, the sixth diode D6 is conducted to receive the PWM control signal from the controller 103 and send the PWM control signal to the input terminal of the driver 104, thereby enabling the driver 104 to provide a discontinuous current to the lighting module 108 according to the PWM control signal.

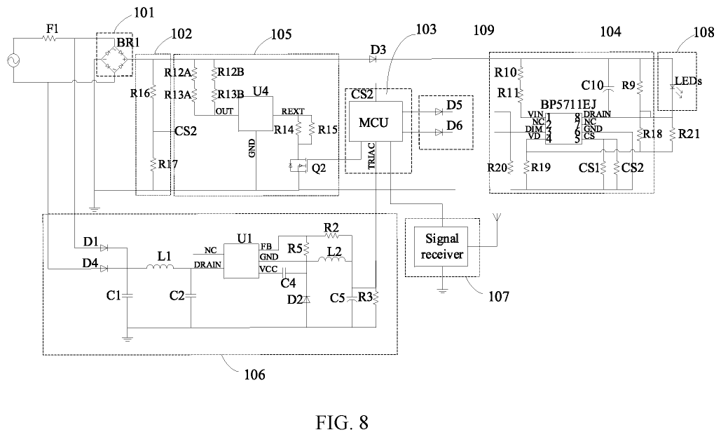

FIG. 8 is a schematic diagram of another example light dimming system consistent with the disclosure. As shown in FIG. 8, on the basis of the embodiments shown in FIG. 2 to FIG. 7, the light dimming system specifically includes the rectifier 101, the voltage acquisitor 102, the controller 103, the driver 104, the dimmer starter 105, the power supplier 106, the signal receiver 107, the lighting module 108, and the conductor 109.

Specifically, the rectifier 101 includes the bridge rectifier BR1, and the rectifier 101 may also include a half-bridge ballast or multiple diodes. The input terminal of the bridge rectifier BR1 in the rectifier 101 is connected to the mains power supply, and the output terminal of the bridge rectifier BR1 is connected to the input terminal of the dimmer starter 105, the input terminal of the driver 104, and the input terminal of the voltage acquisitor 102, respectively.

The voltage acquisitor 102 includes the sixteenth resistor R16 and the seventeenth resistor R17.

The power supplier 106 includes the first diode D1, the fourth diode D4, the first capacitor C1, the second capacitor C2, the first inductor L1, the power management chip U1, the second resistor R2, the third resistor R3, the fifth resistor R5, the fourth capacitor C4, the fifth capacitor C5, and the second inductor L2.

The dimmer starter 105 includes the twelfth resistor R12A, the thirty-second resistor R12B, the thirteenth resistor R13A, the thirty-third resistor R13B, the fourteenth resistor R14, the fifteenth resistor R15, the dimmer start chip U4, and the second switch transistor Q2.

The driver 104 includes the ninth resistor R9, the tenth resistor R10, the eleventh resistor R11, the eighteenth resistor R18, the twenty-first resistor R21, the twentieth resistor R20, the nineteenth resistor R19, the first chip selection resistor CS1, the second chip selection resistor CS2, and the tenth capacitor C10.

The first terminal of the sixteenth resistor R16 is connected to the rectifier 101. The second terminal of the sixteenth resistor R16 is connected to the first terminal of the seventeenth resistor R17 and the input terminal of the controller 103, respectively. The voltage from the mains power supply is rectified and divided, and then is transferred to the controller 103, to enable a microprogrammed control unit (MCU) to process and control the opening and closing of the switch transistor of the dimmer starter 105.

The dimmer starter chip U4 in the dimmer starter 105 is SM2082G. The first terminal of the twelfth resistor R12A is connected to the output terminal of the rectifier 101. The second terminal of the twelfth resistor R12A is connected to the first terminal of the thirteenth resistor R13A. The first terminal of the thirty-second resistor R12B is connected to the output terminal of the rectifier 101. The second terminal of the thirty-second resistor R12B is connected to the first terminal of the thirty-third resistor R13B. The first terminal of the twelfth resistor R12A is connected to the first terminal of the thirty-second resistor R12B. The second terminal of the thirteenth resistor R13A is connected to the second terminal of the thirty-third resistor R13B. The second terminal of the thirty-third resistor R13B is connected to the output terminal of the dimmer start chip U4. The input terminal of the dimmer start chip U4 is connected to the first terminal of the fourteenth resistor R14 and the first terminal of the fifteenth resistor R15, respectively. The second terminal of the fourteenth resistor R14 is connected to the second terminal of the fifteenth resistor R15. The fourteenth resistor R14 is connected in parallel with the fifteenth resistor R15. The second terminal of the fifteenth resistor R15 is connected to the first terminal of the second switch transistor Q2. The control terminal of the second switch transistor Q2 is connected to the output terminal of the controller 103. The second terminal of the second switch transistor Q2 is grounded. When the voltage collected by the voltage acquisitor 102 is a voltage signal indicating there is a dimmer, the MCU outputs a control signal to the control terminal of the second switch transistor Q2 to turn on the second switch transistor Q2, and the dimmer starter works. When the voltage collected by the voltage acquisitor 102 is a voltage signal indicating there is no dimmer, the MCU outputs a control signal to the control terminal of the second switch transistor Q2 to turn off the second switch transistor Q2, and the dimmer starter does not work.

The controller 103 is the MCU. The voltage input terminal CS2 of the MCU is connected to the seventeenth resistor R17 in the voltage acquisitor 102. The rectified DC is divided by the sixteenth resistor R16 and the seventeenth resistor R17, and then is input to the MCU to provide a DC signal for the MCU. The control pin TRIAC of the MCU is connected to the second switch transistor Q2 in the dimmer starter 105. The MCU controls to output the analog control signal or the PWM control signal according to the signal of the voltage input terminal CS2. The output terminal of the MCU is connected to the driver 104 to send the analog control signal or the PWM control signal output by the MCU to the driver 104.

The driver 104 includes the driver chip. The driver chip is BP5711EJ, a highly integrated high-precision linear dimmable LED constant current driver chip, which supports the input of the PMW control signal and the analog control signal, for example, directly controls the current of the lighting module 108 according to the analog control signal or the PWM control signal.

The first terminal of the tenth resistor R10 is connected to the cathode of the third diode D3. The second terminal of the tenth resistor R10 is connected to the first terminal of the eleventh resistor R11. The second terminal of the eleventh resistor R11 is connected to the first input terminal of the driver chip. The first input terminal of the driver chip BP5711EJ is the high voltage start input terminal VIN. The third input terminal of the driver chip is connected to the output terminal of the conductor 109. The third input terminal of the driver chip is connected to the first terminal of the twentieth resistor R20. The third input terminal of the driver chip BP5711EJ is the signal input terminal DIM. The third input terminal of the driver chip is connected to the output terminal of the MCU. The driver chip BP5711EJ controls the current of the lighting module 108 according to the analog control signal or the PWM control signal sent by the MCU. The second terminal of the twentieth resistor R20 is grounded. The second terminal of the nineteenth resistor R19 is grounded. The first terminal of the nineteenth resistor R19 is connected to the fourth input terminal of the driver chip. The fourth input terminal of the driver chip BP5711EJ is the input terminal VD realizing the line voltage compensation function of the driver chip. The fourth output terminal of the driver chip BP5711EJ is the output terminal CS. The first chip selection resistor CS1 is connected in parallel with the second chip selection resistor CS2. The first terminal of the second chip selection resistor CS2 is connected to the fourth output terminal of the driver chip. The second terminal of the chip selection resistor CS2 is grounded. The first chip selection resistor CS1 and the second chip selection resistor CS2 are used as peripheral resistors to limit the current flowing through the lighting module 108. The first terminal of the capacitor C10 is connected to the cathode of the third diode D3. The second terminal of the capacitor C10 is connected to the first output terminal of the driver chip. The ninth resistor R9 is connected in parallel with the capacitor C10. The second terminal of the capacitor C10 is connected to the first terminal of the eighteenth resistor R18. The second terminal of the eighteenth resistor R18 is connected to the first terminal of the nineteenth resistor R19. The twenty-first resistor R21 is connected in parallel with the eighteenth resistor R18. The ninth resistor R9 is connected in parallel with the lighting modules 108. The first output terminal of the driver chip BP5711EJ is the output terminal DRAIN. The saturation current of the output terminal DRAIN is limited by the tenth capacitor C10 and the ninth resistor R9.

The power supplier 106 includes the power management chip connected to the controller 103. The anode of the first diode D1 and the anode of the fourth diode D4 are connected to the mains power supply. The cathode of the first diode D1 is connected to the cathode of the fourth diode D4. The first diode D1 and the fourth diode D4 are connected to form a rectifier circuit, which converts the input AC into DC. The first terminal of the first capacitor C1 is connected to the cathode of the first diode D1. The second terminal of the first capacitor C1 is grounded. The input terminal DRAIN of the first inductor L1 is connected to the cathode of the first diode D1. The second terminal of the inductor L1 is connected to the first terminal of the second capacitor C2. The second terminal of the second capacitor C2 is grounded. The first capacitor C1, the first inductor L1, and the second capacitor C2 form a C-L-C type filter circuit to filter the DC. The second terminal of the first inductor L1 is connected to the input terminal of the power management chip. The feedback terminal FB of the power management chip is connected to the first terminal of the second resistor R2. The first terminal of the fifth resistor R5 is connected to the feedback terminal FB of the power management chip. The output terminal VCC of the power management chip is connected to the second terminal of the fifth resistor R5. The output terminal VCC of the power management chip is connected to the first terminal of the second inductor L2. The second terminal of the second resistor R2 is connected to the second terminal of the second inductor L2. The third output terminal of the power management chip is connected to the first terminal of the fourth capacitor C4. The second terminal of the fourth capacitor C4 is connected to the cathode of the second diode D2. The anode of the second diode D2 is grounded. The first terminal of the fifth capacitor C5 is connected to the second terminal of the second inductor L2. The second terminal of the fifth capacitor C5 is grounded. The third resistor R3 is connected in parallel with the fifth capacitor C5. The second terminal of the third resistor R3 is connected to the input terminal of the controller 103. The third resistor R3 is responsible to output a stable voltage power signal to the controller 103 as a dead load. The second resistor R2 and the fifth resistor R5 output a feedback voltage to the feedback pin according to the output voltage.

The lighting module 108 is the LED lighting device, and the LED lighting device may select the suitable LED lamp type according to the actual needs, for example, select the LED lamp beads or the LED filament lamps according to the functional requirements. The signal receiver 107 includes a signal receiving and sending circuit to receive the dimming instructions from the external devices via radio waves or wireless networks. The external device may be a terminal device or a remote controller. The terminal device may send dimming instructions to the signal receiver 107 via wireless networks, or the remote controller may send dimming instructions to the signal receiver 107 via radio waves. The signal receiver 107 is connected to the MCU and sends the received dimming instructions to the MCU. The MCU controls the output PWM control signal according to the dimming instructions. For example, if the signal receiver 107 receives a dimming instruction to increase the brightness of the LED lighting device, the MCU increases the duty cycle of the PWM control signal, and the driver 104 correspondingly increases the current to the lighting module 108, and then the brightness of the LED lighting device increases.

The conductor 109 includes the fifth diode D5 and the sixth diode D6. The anode of the fifth diode D5 and the anode of the sixth diode D6 are simultaneously connected to the output terminal of the controller 103, and the output terminal of the controller 103 is the output terminal DACIN. The cathode of the fifth diode D5 and the cathode of the sixth diode D6 are simultaneously connected to the input terminal of the driver 104, and the input terminal of the driver 104 is the signal input terminal DIM.

When the mains power supply is controlled by the dimmer, the controller 103 outputs the analog control signal. In this scenario, the fifth diode D5 is conducted, and the analog control signal is sent to the signal input terminal DIM of the driver 104 via the fifth diode D5. Then the driver 104 provides a continuous and constant current to the lighting module 108 according to the analog control signal. Then the mains power supply is not controlled by the dimmer, the controller 103 outputs the PWM control signal. In this scenario, the sixth diode D6 is conducted, and the PWM control signal is sent to the signal input terminal DIM of the driver 104 via the sixth diode D6. Then the driver 104 provides a discontinuous current to the lighting module 108 according to the PWM control signal.

In descriptions of above embodiments, the controller 103 outputs the analog control signal when the mains power supply is controlled by the dimmer, outputs the PWM control signal when the mains power supply is not controlled by the dimmer, controls the outputs of the analog control signal and the PWM control signal via the conductor 109, and adjusts the current signal sent to the lighting module 108 from the driver 104, thereby solving the problem of incompatibility between the light dimming system in the existing technology and the traditional lighting circuit with the wall dimmer.

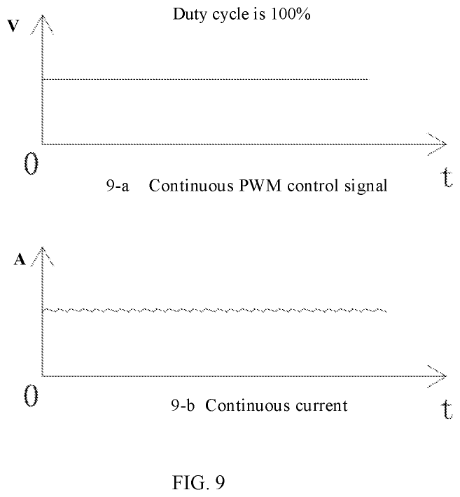

The dimming control principle of the light dimming system consistent with the embodiments of the present disclosure will be described in detail below with reference to FIG. 9 to FIG. 11.

FIG. 9 is a schematic diagram of an example PWM control signal consistent with the disclosure. As shown in FIG. 9-a, when the duty cycle of the PWM control signal is 100%, the MCU outputs a continuous PWM control signal. As shown in FIG. 9-b, the current provided by the driver 104 to the lighting module 108 is the continuous constant current signal according to the continuous PWM control signal.

When the duty cycle is 100%, the MCU outputs the continuous PWM control signal, which is sent to the signal input terminal DIM of the driver chip BP5711EJ. The driver chip BP5711EJ outputs the continuous constant current signal according to the received continuous PWM control signal. The lighting module 108 performs dimming according to the constant current signal sent from the output terminal DRAIN of the driver chip.

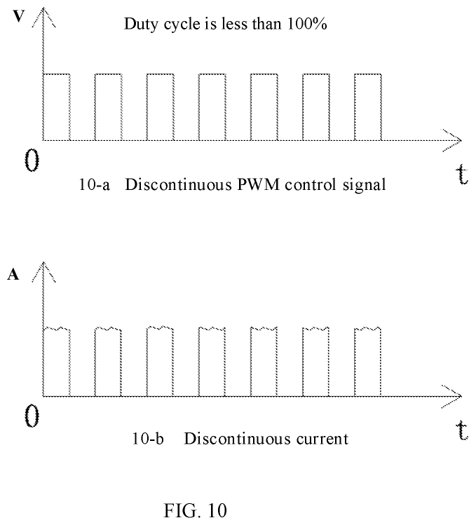

FIG. 10 is a schematic diagram of another example PWM control signal consistent with the disclosure. As shown in FIG. 10-a, when the duty cycle of the PWM control signal is less than 100%, the MCU outputs a discontinuous PWM control signal. As shown in FIG. 10-b, the current provided by the driver 104 to the lighting module 108 is the discontinuous current signal according to the discontinuous PWM control signal.

When the duty cycle is less than 100%, the MCU outputs the discontinuous PWM control signal, which is sent to the signal input terminal DIM of the driver chip BP5711EJ. The driver chip BP5711EJ outputs the discontinuous current signal according to the received discontinuous PWM control signal. The lighting module 108 performs the dimming according to the discontinuous current signal sent from the output terminal DRAIN of the driver chip.

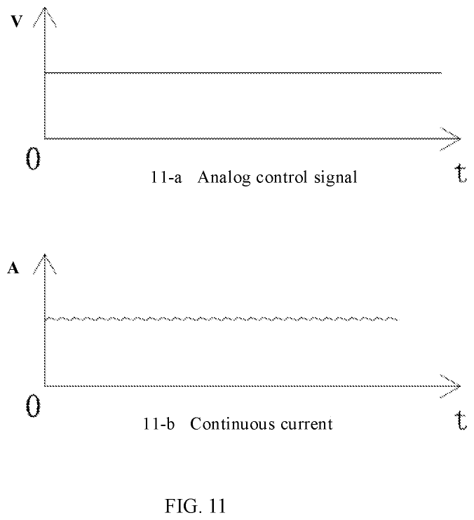

FIG. 11 is a schematic diagram of an example analog control signal consistent with the disclosure. As shown in FIG. 11-a, when the mains power supply is controlled by the dimmer, the MCU outputs a continuous analog control signal. As shown in FIG. 11-b, the current provided by the driver 104 to the lighting module 108 is the continuous current signal according to the continuous analog control signal.

When the mains power supply is controlled by the dimmer, the controller 103 outputs the analog control signal. In this scenario, the fifth diode D5 is conducted, and the analog control signal is sent to the signal input terminal DIM of the driver 104 via the fifth diode D5. The driver chip BP5711EJ outputs the continuous current signal according to the received analog control signal. Then the lighting module 108 performs the dimming according to the continuous current signal sent from the output terminal DRAIN of the driver chip.

In descriptions of above embodiments shown in FIG. 9 to FIG. 11, the MCU outputs the analog control signal when the mains power supply is controlled by the dimmer, and outputs the PWM control signal when the mains power supply is not controlled by the dimmer. The MCU outputs the continuous PWM control signal when the duty cycle is 100%, outputs the discontinuous PWM control signal when the duty cycle is less than 100%, adjusts the current signal provided by the driver 104 to the lighting module 108 according to different input and output signal of the mains power supply, e.g., the analog control signal and PWM control signal, thereby solving the problem of the incompatibility between the light dimming system in the existing technology and the traditional lighting circuits with the wall dimmer.

In the description of the present disclosure, unless otherwise defined and specified, the first feature “on” or “under” the second feature may be a direct contact between the features or may be an indirect contact between the features via an intermediate medium. Moreover, the first feature “above” the second feature may mean that the first feature is directly above or obliquely above the second feature or may simply mean that the first feature is higher in level than the second feature. The first feature “below” the second feature may mean that the first feature is directly below or obliquely below the second feature or may simply mean that the first feature is lower in level than the second feature.

In the above description, the description with reference to the terms “an example embodiment,” “some embodiments,” “for example,” etc. means specific features, structures, materials, or characteristics described consistent with the embodiments or examples are included in at least one embodiment or example of the present disclosure. In this specification, the exemplary descriptions of the above terms do not necessarily refer to the same embodiment or example. Moreover, the specific features, structures, materials, or characteristics described may be combined in any one or more embodiments or examples in a suitable manner. In addition, those skilled in the art may combine different embodiments or examples, or the features of the different embodiments or examples described in this specification without contradicting each other.

Although the above has shown and described the embodiments of the present disclosure, it is intended that the above embodiments be considered as examples only and not to limit the scope of the present disclosure. One of ordinary skill in the art may make changes, modifications, replacements, and transformation to the above embodiments within the scope of the present disclosure. The scope of the disclosure is defined by the claims and their equivalents.

1. A light dimming system comprising:
a rectifier;
a voltage acquisitor connected to the rectifier;
a controller connected to the voltage acquisitor;
a driver connected to the controller and the rectifier;
a dimmer starter connected to the controller; and
a power supplier;
wherein:
the rectifier is configured to connect to a mains power supply via a switch or a dimmer to convert the input alternating current (AC) into a direct current (DC);
the voltage acquisitor is configured to:
receive the DC from the rectifier;
obtain status of the mains power supply; and
send the status of the mains power supply to the controller;
the controller is configured to:
generate a driver control signal according to the status of the mains power supply from the voltage acquisitor and send the driver control signal to the driver, the driver control signal being an analog control signal or a pulse width modulation (PWM) control signal;
generate a conduction control signal in response to the rectifier being connected to the mains power supply via the dimmer; and
send the conduction control signal to the dimmer starter;
the driver is configured to generate a corresponding driving current according to the driver control signal to enable a lighting module to emit light;
the dimmer starter is configured to turn on the dimmer according to the conduction control signal; and
the power supplier is connected to the mains power supply and provides power for the controller.

2. The light dimming system of claim 1, wherein the controller is further configured to:
generate the analog control signal as the driver control signal in response to the status of the mains power supply being connected through the dimmer;
generate the PWM control signal as the driver control signal in response to the status of the mains power supply not connected through the dimmer.

3. The light dimming system of claim 1, wherein the driver is further configured to:
output a continuous driving current to the lighting module according to the analog control signal in response to the driver control signal being the analog control signal;
output the continuous driving current to the lighting module in response to the driver control signal being the PWM control signal and a duty cycle of the PWM control signal being 100%; and
output a discontinuous driving current to the lighting module in response to the driver control signal being the PWM control signal and the duty cycle of the PWM control signal being less than 100%.

4. The light dimming system of claim 3, wherein the driver includes:
a driver chip;
a ninth resistor;
a tenth resistor;
an eleventh resistor;
an eighteenth resistor;
a nineteenth resistor;
a twentieth resistor;
a twenty-first resistor;
a first chip selection resistor;
a second chip selection resistor; and
a tenth capacitor;
wherein:
a first terminal of the driver chip is connected to the rectifier sequentially through the tenth resistor and the eleventh resistor;
a third terminal of the driver chip is connected to the controller and is grounded through the twentieth resistor;
a fourth terminal of the driver chip is grounded through the nineteenth resistor, is connected to an eighth terminal of the driver chip through the twenty-first resistor, and is connected to the rectifier sequentially through the eighteenth resistor and the ninth resistor;
a fifth terminal of the driver chip is grounded through the first chip selection resistor and the second chip selection resistor connected in parallel;
the eighth terminal of the driver chip is connected to the rectifier through the tenth capacitor.

5. The light dimming system of claim 1, further comprising:
a signal receiver connected to the controller, and configured to receive dimming instructions from external devices and send the received dimming instructions to the controller;
wherein:
the controller is further configured to receive the dimming instructions and adjust the driver control signal according to the dimming instructions.

6. The light dimming system of claim 1, wherein:
the lighting module is connected to the driver and configured to emit light under the driving current.

7. The light dimming system of claim 1, further comprising:
a conductor;
wherein:
the controller includes a first output terminal for outputting the analog control signal and a second output terminal for outputting the PWM control signal; and
the conductor is connected to the first output terminal of the controller, the second output terminal of the controller, and the drive, respectively, and the conductor is configured to:
receive the analog control signal from the first output terminal of the controller and send the analog control signal to the drive; or
receive the PWM control signal from the second output terminal of the controller and send the PWM control signal to the drive.

8. The light dimming system of claim 7, wherein:
the conductor includes a fifth diode and a sixth diode; and
an anode of the fifth diode is connected to the first output terminal of the controller, the anode of the sixth diode is connected to the second output terminal of the controller, and a cathode of the fifth diode and the cathode of the sixth diode are connected to an input terminal of the drive.

9. The light dimming system of claim 1, wherein the dimmer starter includes:
a twelfth resistor;
a thirteenth resistor;
a fourteenth resistor;
a fifteenth resistor;
a dimmer start chip; and
a second switch transistor;
wherein:
the input terminal of the dimmer start chip is connected to the first terminal of the second switch transistor through the fourteenth resistor and the fifteenth resistor connected in parallel;
a control terminal of the second switch transistor is connected to the controller, and a second terminal of the second switch transistor is grounded; and
the output terminal of the dimmer start chip is connected to the rectifier sequentially through the twelfth resistor and the thirteenth resistor.

10. The light dimming system of claim 1, wherein the power supplier includes:
a first diode;
a second diode;
a fourth diode;
a first capacitor;
a second capacitor;
a fourth capacitor;
a fifth capacitor;
a first inductor;
a second inductor;
a second resistor;
a third resistor;
a fifth resistor; and
a power management chip;
wherein:
the anode of the first diode is connected to the first input terminal of the mains power supply, the anode of the second diode is connected to the second input of the mains power supply, and the cathode of the first diode and the cathode of the second diode are connected to the input terminal of the first inductor;
the second terminal of the first inductor is connected to the input terminal of the power management chip, the input terminal of the first inductor is grounded through the first capacitor, and the second terminal of the first inductor is grounded through the second capacitor;
a feedback terminal of the power management chip is connected to the controller through the second resistor, and is connected to a ground terminal of the power management chip through the fifth resistor;
the output terminal of the power management chip is connected to the cathode of the second diode through the fourth capacitor, and the anode of the second diode is grounded; and
one terminal of the second inductor is connected to the ground terminal of the power management chip, the other terminal is grounded through the fifth capacitor connected in parallel with the third resistor.
